(19) United States
(12) Patent Application Publication
(10) Pub. No.: US 2010/0082794 A1
(43) Pub. Date: Apr. 1, 2010

(54) HOME NETWORK VISUALIZATION

(75) Inventors: ROBERT HARDACKER, Escondido, CA (US); Christopher Jensen Read, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/243,131

(22) Filed: Oct. 1, 2008

(51) Int. Cl. G06F 15/173

(52) U.S. Cl. 709/223

(57) ABSTRACT

Intuitive visualization of a home network is provided by providing on screen images of devices in the network around an image of the TV, and by establishing sizes, motion, and other visualization features of the images to reflect selections, bandwidths, different sub-networks, etc.

### FIELD OF THE INVENTION

This application generally pertains to providing intuitive visualization of networked devices, typically within the home.

### BACKGROUND OF THE INVENTION

TVs and other consumer electronic (CE) products increasingly are networked to enable consumers to share content with other people or on other devices they own. Visualizing the network, identifying the various devices and what services or content that is available is a difficult task.

The Digital Living Network Alliance (DLNA) defines a series of common protocols that enable interoperation and device and content discovery, but it, doesn't define the presentation of this information. Presentation and operation are part of “user interface” and as understood herein, the power of one or more graphic engines in the network may be leveraged to visually represent complex information in a simple, intuitive fashion.

### SUMMARY OF THE INVENTION

A method includes presenting on a video monitor an image of a first device, such as a TV, that is in a home network. The method also includes presenting on the monitor images of at least second and third devices in the home network. The images of the second and third devices can be arranged on an orbital path around the image of the first device. In some embodiments, an image of a device is enlarged in response to a user selection of the image. In other embodiments, the images of the second and third devices move along the orbital path. In other embodiments, a size of an image of a device is established based on the bandwidth and/or amount of available content of the associated device. In other embodiments, respective first and second orbital paths are established around each of which one or more images of devices are arranged for respective first and second networks associated with the first device. The image of the first device can be displayed at the center of both paths or the image of the first device might be displayed at the center of only one path.

In another aspect, a system includes a processor and display communicating with the processor. The processor is configured to cause the display to present an image of a TV and, arranged along an orbital path around the image of the TV, images of at least first and second devices in a home network communicating with the TV. An image of a device can be enlarged in response to selection of the device. Images of non-selected devices can be moved to a cluster on the path on a side of the image of the TV that is opposite an image of a selected device.

In another aspect, a system includes a processor and display communicating with the processor. The processor is configured to establish respective first and second paths on the display around each of which one or more images of devices are arranged for respective first and second networks associated with a TV.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIGS. 2-6 are example screen shots of network visualizations in accordance with present principles; and

FIG. 7 is an example non-limiting flow chart of logic that can be used to generate the screen shots, which can be three dimensional representations that enable a sense of depth and thus enhanced visual impact.

### DETAILED DESCRIPTION OF THE PREFERRED EMBODIMENT

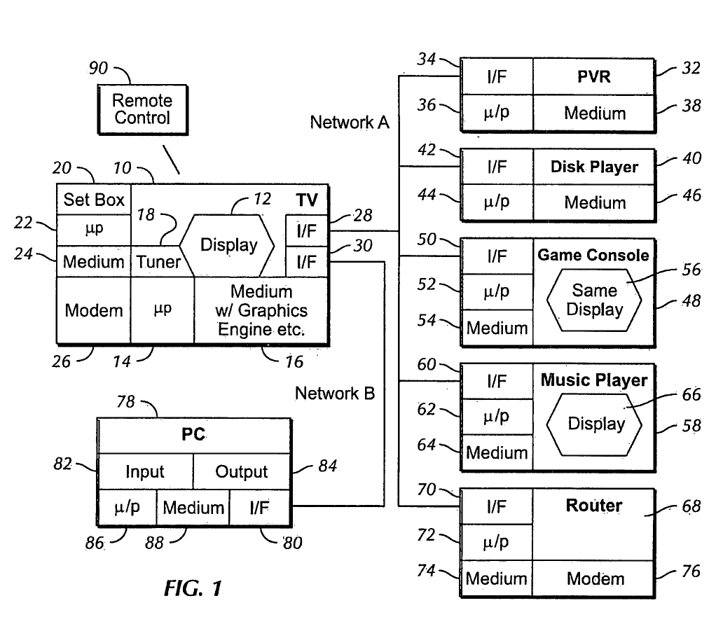

FIG. 1 shows an audio-video device such as a television 10 in a home network environment. The TV 10 is a non-limiting example of a central network device that may be defined as such by the network manufacturer by default or by the user.

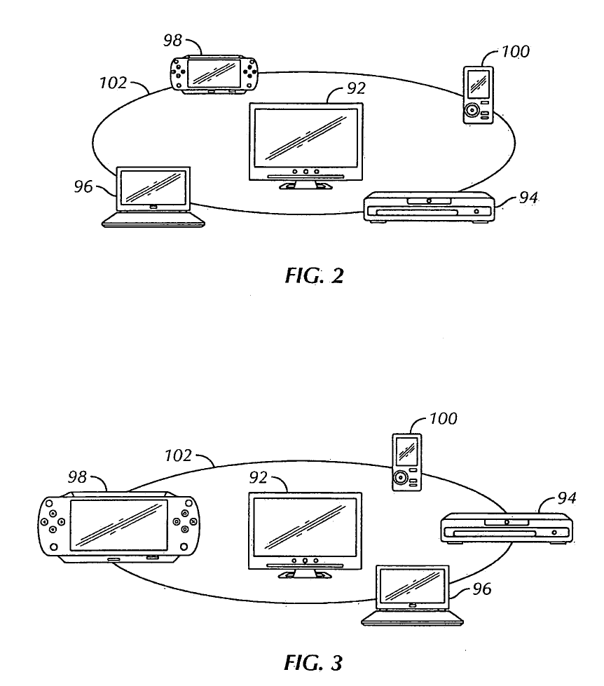

As shown, the TV 10 includes a video display 12 on which the screen shots shown in FIGS. 2-6 may be presented under control of a TV processor 14 accessing a tangible computer-readable medium 16 such as but not limited disk or solid state storage, a description that applies to the other computer-readable media divulged herein. Among other things, the medium 16 may bear instructions to undertake the logic herein and it may also bear other software modules such as but not limited to a graphics engine. Alternatively, the graphic engine may be embodied as a separate hardware module accessible to the TV processor 14.

A TV tuner 18 may also be included in the TV 10 and/or in a set box 20 such as a set-top box or set-back box. The set box 20 may include a set box-processor 22 and set box computer readable medium 24, as well as an Internet interface such as but not limited to a modem 26 for providing Internet content to the TV 10 for viewing thereof.

The TV 10 typically also includes one or more network interfaces. In one implementation the TV 10 includes a first network interface 28 such as but not limited a high definition multimedia interface (HDMI) or Ethernet interface and a second interface 30 such as but not limited to a universal serial bus (USB) interface or wireless interface such as a Bluetooth or Wi-Fi interface. These interface types are examples only and non-limiting.

The first interface 28 can interface the TV 10 with a “network A” as shown in FIG. 1, which can include, e.g., a personal video recorder (PVR) 32 with complementary interface 34, PVR processor 36, and computer readable medium 38. Also, a disk player 40 may communicate with network “A” using an interface 42 communicating with a disk player processor 44 and computer readable medium 46. Furthermore, a game console 48 may communicate with network “A” using an interface 50 communicating with a game console processor 52 and computer readable medium 54. The game console 48 may be portable and may communicate via wired or wireless paths. The game console 48 can include a game console monitor 56 for displaying video embodying computer games.

In addition, a music player 58 may communicate with network “A” using an interface 60 communicating with a music player processor 62 and computer readable medium 64. The music player 58 may be portable and may communicate via wired or wireless paths. The music player 58 can include a music player monitor 66 for displaying video embodying computer games.

If desired, a network router 68 may be provided on the network “A”, it being understood that all the components discussed above may be connected to network “A” by virtue of being connected to the router 68 which in some embodiments may function as network hub. In any case, the router 68 can include a network interface 70 configured to communicate with the network “A”, a router processor 72, and a computer readable medium 74. An internet interface such as but not limited to a modem 76 may also be provided in the router 68 if desired. The router 68 may provide a link to nearby peer-to-peer devices that may also appear on the screen shots shown below if desired.

As also shown in FIG. 1, a computer such as a personal computer 78 may communicate with the TV 10 over a second network (“B”) by means of an interface 80. The PC 78, which typically includes one or more input devices 82 such as mice, keyboards, etc. and one or more output devices 84 such as monitors, printers, etc., can be controlled by a PC processor 86 accessing one or more computer readable media 88. One or more of the devices in FIG. 1 may be controlled by one or more wireless hand-held remote controls 90.

While the TV processor 14 may execute the logic herein, which may be stored on the TV medium 16, to present the screen shots of FIGS. 2-6 in accordance with present principles, it is to be understood that other processors in FIG. 1 in addition to or in lieu of the TV processor 14 may execute the logic, which may be distributed over multiple computer media.

FIG. 2 shows a first screen shot that may be presented on the TV display 12 to enable a person to visualize his or her home network. The screen shot may be displayed when a user operates the remote control 90 to cause the TV 10 to enter a “setup” menu or “network” menu. For simplification, the screen shot shown in FIG. 2 assumes a single network; furthermore, not all the components shown in FIG. 1 are shown in FIG. 2, for ease of description.

As shown, the screen shot displays an image 92 of the TV 10 centrally on screen, with the understanding that while the TV 10 may be the default “central” device, the user may be afforded the opportunity to select another device to be the “central” device. Images 94, 96, 98, 100, respectively representing the disk player 40, PC 78, game console 48, and music player 58, are arranged around the image 92 of the TV as shown. Each image in FIG. 2 may be an actual photographic-like image of its respective component. Text may be provided on one or more icons as by overlaying the text on an,icon in response to, e.g., hovering the screen cursor over an icon.

As shown, the images 94-100 may be arranged along a path 102 describing an orbit (which may be circular, elliptical as shown, or other shape) around the image 92 of the TV. The images 94-100 may be caused to revolve around the TV image 92 along the path 102 if desired, and/or the images 94-100 may remain stationary on the path 102. The path 102 may be displayed on screen as shown or it may be transparent to the viewer.

The path 102 may be presented in color and the color can change to, for example, indicate network status. For example, the color of the path 102 may be green when the network is functional and red when it is not.

The screen shot shown in FIG. 2, in addition to providing an easy and intuitive visualization of a home network, can also provide a user interface. As an example, a person can manipulate the remote control 90 to move a screen cursor over an image in FIG. 2 and select the image to indicate a desire that the corresponding device be a source or sink of content. Thus, the game console image 98 may be selected to indicate a desire to display content in the game console 48 on the TV 10.

When an image is selected, to provide visual confirmation, the non-selected images may be clustered on one side of the screen and the selected image moved to the opposite side of the screen as shown in FIG. 3. As also shown, the selected image (in this example, the game console image 98) may also be enlarged for emphasis or easier viewing. The size of an image may also be established in proportion to the bandwidth of the associated device, with the images of devices having relatively large bandwidths being relatively larger than the images of devices with relatively low bandwidths. In any case, re-selecting the image 98 in FIG. 3 can cause content from the associated component to be displayed on, e.g., the TV 10.

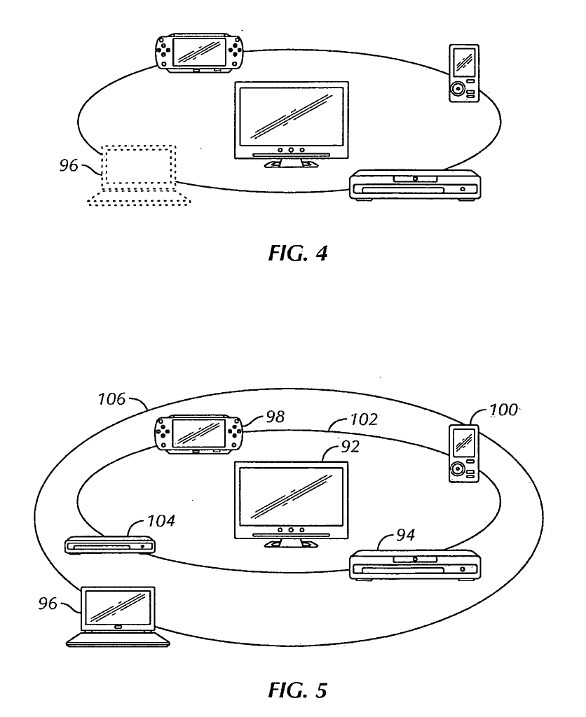

As shown in FIG. 4, the image (in this example, the PC image 96) of an offline or deenergized device may be “grayed out”.

FIG. 5 shows that multiple networks may be presented as corresponding orbital paths around the TV 10. For instance, assume that the disk player 40, game console 48, music player 58, and router 68 (represented in FIG. 5 by a router image 104) are on network “A” while the PC 78 is on the network “B” of FIG. 1. Accordingly, the disk player image 94, game console image 98, music player image 100, and router image 104 are presented on an “A” orbit path 102, while the PC image 96 is presented on a “B” orbit path 106 that surrounds the “A” orbit path 102, with the TV image 92 in the center of both orbits.

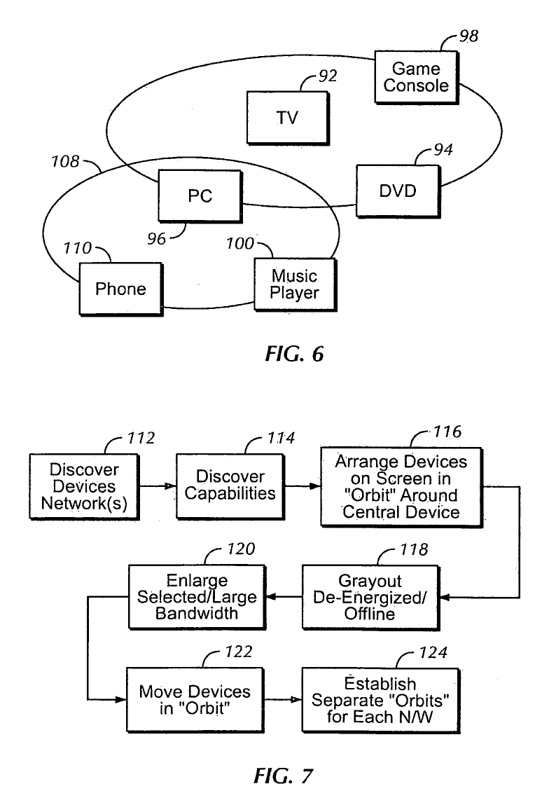

Alternatively, as shown in FIG. 6, if a device such as the PC 78 is a “bridge” to devices on a secondary network (assume for FIG. 6 that the music player 58 and a wireless telephone are on the secondary network with the PC 78), the secondary network can be represented as an orbit path 108 that is separate from the path 102 around the TV image 92. Corresponding music player image 100 and phone image 110 can be shown on the orbit path 108 in the manner of “moons” of the bridging device, in this case represented by the PC image 96, with the PC image 96 being in the center of the secondary orbit path.

FIG. 7 shows logic that may be employed to generate the screen shots of FIGS. 2-6, it being understood that the logic of FIG. 7 need not temporally follow the sequence of steps shown. Block 112 indicates that devices on the home network may be discovered in accordance with principles known in the art, e.g., using universal plug-n-play UPnP) principles, “Bonjour” principles, etc. The capabilities of the devices such as bandwidth, display capability, storage capability, etc. may be discovered at block 114.

At block 116, in response to a user invoking, e.g., the screen shot of FIG. 2 described above, images of each of the devices discovered on the network or networks are displayed, arranged in an “orbital” configuration around an image of the central device, e.g., the TV image 92. As described in the case of FIG. 4, images of offline/deenergized devices may be grayed out at block 118. As described in the case of FIG. 3, images of selected devices may be enlarged at block 120, and/or images of high bandwidth devices may be relatively enlarged compared to images of lower bandwidth devices.

If desired, at block 122 the images may be cause to revolve around the central device image along the orbital path. Separate orbital paths may be established at block 124 for respective networks.

While the particular HOME NETWORK VISUALIZATION is herein shown and described in detail, it is to be understood that the subject matter which is encompassed by the present invention is limited only by the claims.

What is claimed is:

1. A method, comprising:
presenting on a video monitor an image of a first device in a home network;
presenting on the monitor images of at least second and third devices in the home network, the images of the second and third devices being arranged on an orbital path around the image of the first device; and
executing at least one act selected from the group of acts including:
enlarging an image of a device in response to a user selection of the image;
causing the images of the second and third devices to move along the orbital path;
establishing a size of an image of a device based at least on part on a bandwidth of the associated device;
establishing respective first and second orbital paths around each of which one or more images of devices are arranged for respective first and second networks associated with the first device.

2. The method of claim 1, comprising enlarging an image of a device in response to a user selection of the image.

3. The method of claim 1, comprising causing the images of the second and third devices to move along the orbital path.

4. The method of claim 1, comprising establishing a size of an image of a device based at least on part on a bandwidth of the associated device.

5. The method of claim 1, comprising establishing respective first and second orbital paths around each of which one or more images of devices are arranged for respective first and second networks associated with the first device.

6. The method of claim 1, comprising graying out an image if the associated device is offline.

7. The method of claim 5, wherein the image of the first device is displayed at the center of both paths.

8. The method of claim 5, wherein the image of the first device is displayed at the center of only one path.

9. System comprising:
processor;
display communicating with the processor;
the processor configured to cause the display to present an image of a TV and arranged along an orbital path around the image of the TV, images of at least first and second devices in a home network communicating with the TV, an image of a device being enlarged in response to selection of the device, images of non-selected devices being moved to a cluster on the path on a side of the image of the TV opposite an image of a selected device.

10. The system of claim 9, wherein the processor is configured to cause images of the first and second devices to move along the orbital path.

11. The system of claim 9, wherein the processor is configured to establish a size of an image of a device based at least on part on a bandwidth of the associated device.

12. The system of claim 9, wherein the processor is configured to establish respective first and second orbital paths around each of which one or more images of devices are arranged for respective first and second networks associated with the TV.

13. System comprising:
processor;
display communicating with the processor;
the processor configured to establish respective first and second paths on the display around each of which one or more images of devices are arranged for respective first and second networks associated with a TV.

14. The system of claim 13, wherein the processor is configured to cause the display to present an image of the TV and arranged along an orbital path around the image of the TV, images of at least first and second devices in a home network communicating with the TV, an image of a device being enlarged in response to selection of the device, images of non-selected devices being moved to a cluster on the path on a side of the image of the TV opposite an image of a selected device.

15. The system of claim 13, wherein the processor is configured to cause images of devices to move along at least one orbital path.

16. The system of claim 13, wherein the processor is configured to establish a size of an image of a device based at least on part on a bandwidth of the associated device.

17. The system of claim 13, wherein the processor is configured to gray out an image of a device that is not online on a network.

18. The system of claim 13, wherein the first path surrounds an image of the TV and the second path surrounds an image of a device on the first path.
